(19) United States
(12) Patent Application Publication
(10) Pub. No.: US 2023/0214923 A1
(43) Pub. Date: Jul. 6, 2023

(54) INFORMATION-DENSE USER INTERFACE FOR VISUALIZING ASSET PRICES AND DEFINING TRANSACTION PARAMETERS

(71) Applicant: Goldman Sachs & Co. LLC, New York, NY (US)

(72) Inventor: Christopher M. Churchman, New York, NY (US)

(21) Appl. No.: 18/092,863

(22) Filed: Jan. 3, 2023

Related U.S. Application Data
(60) Provisional application No. 63/296,413, filed on Jan. 4, 2022.

(51) Int. Cl. G06Q 40/04

(52) U.S. Cl. CPC G06Q 40/04

(57) ABSTRACT

Various user interfaces are disclosed. A polling user interface enables users to predict asset prices. A price prediction user interface displays historical price data for an asset overlaid on an indication of the corresponding distributions of price predictions for the asset (e.g., as provided by users via the polling user interface). A derivative-definition user interface enables a user to define the parameters for a derivative transaction related to one or more assets. The derivative-definition user interface may also enable the user to request implementation of the transaction (e.g., by submitting the transaction parameters to a trading platform). An order placement user interface may enable a user to define and place an order for a derivative. The order placement user interface may also provide intra-trade updates regarding process of the order (e.g., notifications of executed fills and price actions).

### BACKGROUND

### 1. Technical Field

The subject matter described relates generally to user interfaces and, in particular, to information-dense user interfaces for visualizing asset price data using computations based on numerous scenarios as well as monitoring and defining parameters for transactions.

### 2. Problem

Successfully predicting how the price of a given asset will evolve over time can be highly profitable. Conversely, traders who rely on inaccurate predictions for asset pricing can lose all or a substantial percentage of their investments. However, the prices of many assets are driven by numerous factors and both the accuracy and reliability of predictions varies significantly. Some existing systems provide traders with access to price predictions, but viewing predictions alone makes it difficult to evaluate the predictions or understand the historical context of those predictions.

Understanding the potential outcomes of obtaining a derivative of an asset is arguably an even more complex problem. A derivative can be defined with multiple parameters, such as a put price, a spot price, an upper knock out price and corresponding time frame (e.g., a start time and end time), a lower knock out price and corresponding time frame (e.g., a start time and end time), a strike price, an expiration date, or the like. Specific values for these parameters combine to result in a price for a derivative as well as a universe of potential profit and loss scenarios. Existing systems make it very difficult for a trader to understand the universe of scenarios or place those scenarios in historical context. Typically, the relevant information, if it is available at all, is distributed across multiple spreadsheets, applications, and databases, which the trader must switch between and interpret to understand the balance of risk and reward for a derivative trade. Consequently, effectively using such systems requires a great deal of skill and experience (and thus training time) and, even when used effectively, has a high propensity for human errors resulting from the trader not correctly drawing correlations between disparate pieces of data in the spreadsheets.

Furthermore, many traders now work at least part of the time from computing devices with relatively small screens, such as smartphones or tablets. This further accentuates the problems with existing systems. Navigating large data sets in multiple spreadsheets on a single, small screen can be frustrating for the trader and also increases the risk that important correlations will be missed. These small screens also place limitations on user interfaces as the amount of screen space available for presenting information and user controls is limited.

### SUMMARY

The above and other problems may be addressed by a computing system with an information-dense user interface. In various embodiments, the user interface includes a historical data portion and a parameter-definition portion. The historical data portion visualizes historical data relating to the price of one or more assets while the parameter-definition portion enables the user to define parameters for a derivative of one or more of the assets. The historical data portion, the parameter-definition portion, or both may include one or more overlays/underlays that provide additional information about the assets or defined derivative. Thus, the user-interface may present a large amount of information on a single (potentially small) screen simultaneously, enabling the user to quickly and intuitively understand the context of a derivative and the potential impact of parameter changes on the derivative.

In some embodiments, the user interface includes controls in a pre-trade view that enable the user to place an order for a defined asset or derivative. The order may be sent to a trading platform to be implemented. During implementation, the user interface may transition into an intra-trade view that displays substantially real-time information regarding implementation of the placed order. For example, as the order progresses, information (e.g., visual indicators) describing executed fills and price actions may be added to the user interface.

### BRIEF DESCRIPTION OF THE DRAWINGS

FIG. 1 is a block diagram of a networked computing environment suitable for providing a trading app with an information-dense user interface, according to one embodiment.

FIG. 2 is a block diagram of the analytics server shown in FIG. 1, according to one embodiment.

FIG. 3 is a block diagram of one of the client devices shown in FIG. 1, according to one embodiment.

FIG. 4A is an shows a first embodiment of an information-dense user interface overlaying historical price data for an asset with a distribution of price predictions provided by other users.

FIG. 4B shows a second embodiment of an information-dense user interface overlaying historical price data for an asset with a price prediction distribution.

FIG. 4C illustrates a first part of an exemplary information-dense user interface that enables a user to enter price predictions, according to one embodiment.

FIG. 4D illustrates a second part of the exemplary information-dense user interface of FIG. 4C, according to one embodiment.

FIG. 5A shows an example information-dense user interface being used to set the parameters of a vanilla put transaction, according to one embodiment.

FIG. 5B shows the information-dense user interface being used to set the parameters of a call spreads transaction, according to one embodiment.

FIG. 5C shows the information-dense user interface being used to set the parameters of a 1×2×1 call fly transaction, according to one embodiment.

FIG. 5D shows the information-dense user interface being used to set the parameters of a call reverse knockout (RKO) transaction, according to one embodiment.

FIG. 5E shows the information-dense user interface being used to set the parameters of a call window knockout (WKO) transaction, according to one embodiment.

FIG. 5F shows the information-dense user interface being used to set the parameters of a transaction using multiple underlying assets, according to one embodiment.

FIG. 6A shows a smartphone version of the information-dense user interface that includes contours indicating possible outcomes of a put transaction, according to one embodiment.

FIG. 6B shows the smartphone version of the information-dense user interface with contours indicating possible outcomes of a put spread transaction, according to one embodiment.

FIG. 6C shows the smartphone version of the information-dense user interface with contours indicating possible outcomes of a WKO transaction, according to one embodiment.

FIG. 7A shows an information-dense user interface for placing an order for a derivative before the order is placed, according to one embodiment.

FIG. 7B illustrates the use of a pop-up menu to customize the information-dense user interface of FIG. 7A, according to one embodiment.

FIG. 7C illustrates the information-dense user interface of FIG. 7A after the order has been placed, according to one embodiment.

FIG. 8 shows a portion of a spreadsheet including some of the data presented in the information-dense user interfaces of FIGS. 5A through 7C.

FIG. 9 is a flowchart of a method for generating an information-dense user interface with historical price data for an asset overlaid with a price prediction distribution, according to one embodiment.

FIG. 10 is a flowchart of a method for updating parameters of a transaction using an information-dense user interface, according to one embodiment.

FIG. 11 is a flowchart of a method for placing one or more orders to implement a derivative using an information-dense user interface and receiving intra-trade updates regarding progress of the orders, according to one embodiment.

FIG. 12 is a block diagram of an example computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Example Systems

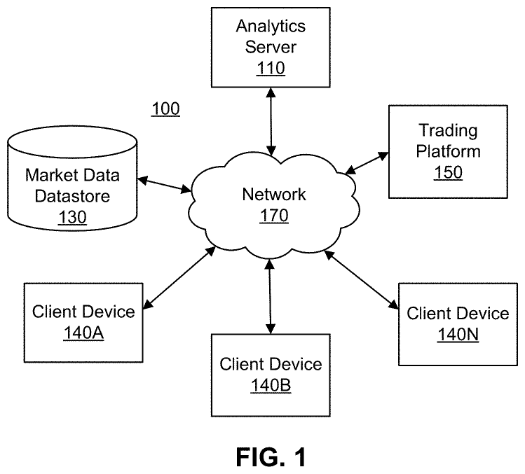

FIG. 1 illustrates one embodiment of a networked computing environment 100 suitable for providing a trading app with an information-dense user interface. In the embodiment shown, the networked computing environment 100 includes an analytics server 110, a market data datastore 130, one or more client devices 140A, 140B, . . . , 140N, and a trading platform 150, all connected via a network 170. In other embodiments, the networked computing environment 100 includes different or additional elements. In addition, the functions may be distributed among the elements in a different manner than described.

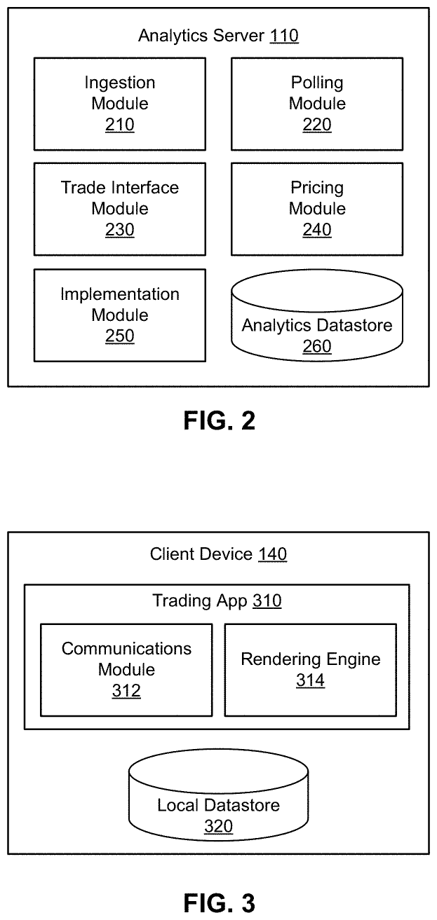

The analytics server 110 includes one or more computing devices that analyze market data to obtain metrics that drive the information-dense user interface. In one embodiment, the metrics used by analytics server 110 include historical price data for one or more assets over one or more time periods. For example, the analytics server 110 may obtain minimum, maximum, opening, and closing prices for the assets for each day, week, or other time period over a region of interest (e.g., the last month, six months, year, five years, etc.). Other metrics of interest may be calculated, such as the median or mean price during each time period. The analytics server 110 may also periodically poll a set of users (e.g., traders or financial analysts) for predictions of the price of at least some of the assets for a future time period (e.g., the next day or week) and aggregate the predictions for display in a user interface. Further, the analytics server 110 may pre-calculate pricing for one or more derivatives using a variety of different parameters and enable users to obtain desired derivatives. The pre-calculation can include determining pricing for multiple financial instruments and calculating a variety of statistical measures (e.g., payout ratios, evolution of sensitivities/Greeks, and the like) for each instrument in different scenarios. In one embodiment, the analytics server 110 calculates pricing and statistical measures using a set of parameter values and uses interpolation routines to provide pricing and statistical measures with higher information density than is calculated directly from the parameter values substantially in real time. Various embodiments of the analytics server 110 are described in greater detail below with reference to FIG. 2.

The market data datastore 130 includes one or more computer-readable media that store market data including prices for assets. Although the market data datastore 130 is shown as a distinct entity, the market data datastore may be part of the analytics server 110. Furthermore, while the market data datastore 130 is shown as a single entity, the described functionality may be provided by multiple devices working together (e.g., as a distributed database). In one embodiment, the market data includes information about each transaction made on one or more exchanges involving one or more assets that are tracked by the analytics server 110. The information for a transaction may include the asset or assets traded, the price, a timestamp indicating when the transaction occurred, and derived data, such as volatility surfaces and discount curves. The information for the transaction may include additional data, such as an identifier of the buyer, an identifier of the seller, an identifier of the trading platform or exchange through which the transaction occurred, etc. The market data datastore 130 may receive market data (e.g., from computing systems of the exchanges or the trading platform 150) in periodic batches (e.g., one an hour or once a day). Additionally or alternatively, market data may be received in one or more continuous or semi-continuous data streams.

The client devices 140 can be any computing devices configured to interact with the analytics server 110. Although FIG. 1 shows three client devices 140 (a first client device 140A, a second client device 140B, and an Nth client device 140N), the networked computing environment may include any number of such devices. The client devices 140 present one or more user interfaces for displaying information regarding assets generated by the analytics server 110. In various embodiments, the client device 140 provides one or more of a polling user interface, a price prediction distribution user interface, a derivative-definition user interface, or an order placement user interface.

the polling user interface is provided to client devices associated with to a subset of users designated for predicting asset prices and prompts those users to predict the price of one or more assets for an upcoming time period (e.g., the next day or week). The price prediction user interface displays historical price data for an asset overlaid on an indication of the corresponding distributions of price predictions for the asset (e.g., as provided by users via the polling user interface). The derivative-definition user interface enables the user to define the parameters for a derivative transaction related to one or more of the assets. The derivative-definition user interface may also enable the user to request implementation of the transaction (e.g., by submitting the transaction parameters to the trading platform 150). Alternatively, the order placement user interface may enable a user to define and place an order for a derivative. The order placement user interface may also provide intra-trade updates regarding process of the order (e.g., notifications of executed fills and price actions). Various embodiments of the client devices 140 and user interfaces are described in greater detail below, with reference to FIGS. 3 through 7C.

The trading platform 150 includes one or more computing devices that receive transaction parameters (e.g., directly from a client device 140 or via the analytics server 110) to implement the defined transaction. For example, a trader may use a user interface displayed on a client device 140 to define the parameters for a EURUSD put, RKO, or WKO, etc., and then use a control in the user interface to request that the transaction be implemented. The trading platform 150 may receive the request (including the defined parameters) from the client device 140 and obtain the requested derivative. The trading platform may provide updates to the client device 140 or the analytics server 110 indicating progress or other metadata regarding the order status (e.g., notifications of executed fills, working limits, and price actions).

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

FIG. 2 illustrates one embodiment of the analytics server 110. In the embodiment shown, the analytics server 110 includes an ingestion module 210, a polling module 220, a trade interface module 230, a pricing module 240, an implementation module 250, and an analytics datastore 260. In other embodiments, the analytics server 110 includes different or additional elements. In addition, the functions may be distributed among the elements in a different manner than described.

The ingestion module 210 obtains data regarding one or more assets (e.g., from the market datastore 130). The ingestion module 210 may obtain raw price data for assets, metrics calculated from the raw price data (e.g., maximum, minimum, opening, and closing prices), or both. In cases where raw price data is obtained, the ingestion module 210 may calculate some or all of the metrics. Furthermore, the ingestion module 210 may create additional secondary metrics using metrics obtained from external sources. For example, if the ingestion module 210 retrieves daily mean prices from the market data datastore 130, the ingestion module may calculate weekly and monthly mean prices from the daily mean prices. The ingestion module 210 may store a local copy of the obtained data and any calculated metrics (e.g., in the analytics datastore 260).

The polling module 220 generates a user interface that overlays historical price data for an asset with a price prediction distribution. In various embodiments, the polling module 220 periodically receives predictions for the price of one or more assets in an upcoming time period. For example, the polling module 220 may identify a set of client devices 140 belonging to users designated to provide predictions of the price of one or more assets of interest. The same users may be prompted to provide predictions for all of the assets of interest or different users may be prompted for different assets. The users may be incentivized to provide predictions using gamification techniques, such as providing a leaderboard of users who provided the most accurate predictions for a previous time period or previous time periods (e.g., with more recent time periods being weighted more heavily than time periods that are further in the past). Furthermore, is some embodiments, the contribution of predictions provided by users to the price prediction distribution may be weighted based on the accuracy of their prior predictions.

In one embodiment, the polling module 220 sends a request to client devices 140 in the set that causes the client devices 140 to prompt the users to provide a prediction of the price of one or more of the assets of interest for the upcoming time period. A user may use various user interfaces and approaches to enter predictions. In one embodiment, the users are prompted within an app running on the client device to submit their predictions and provided with a corresponding interface for entering the predictions. For example, the user may input price estimates for a set of assets by positioning a corresponding set of sliders in a window or typing them into a form. Alternatively, the polling module 220 may send the request through other channels, such as via email or instant messenger. The users may be shown a chart illustrating the price of the asset in preceding time periods (e.g., a candlestick chart indicating the daily or weekly minimum, maximum, opening, and closing prices of the asset for the last week, month, six months, or year, etc.) to aid in estimating the price for the upcoming time period. In another embodiment, software running on the client devices 140 causes the users to be prompted to provide predictions and the polling module 220 passively receives the submitted predictions.

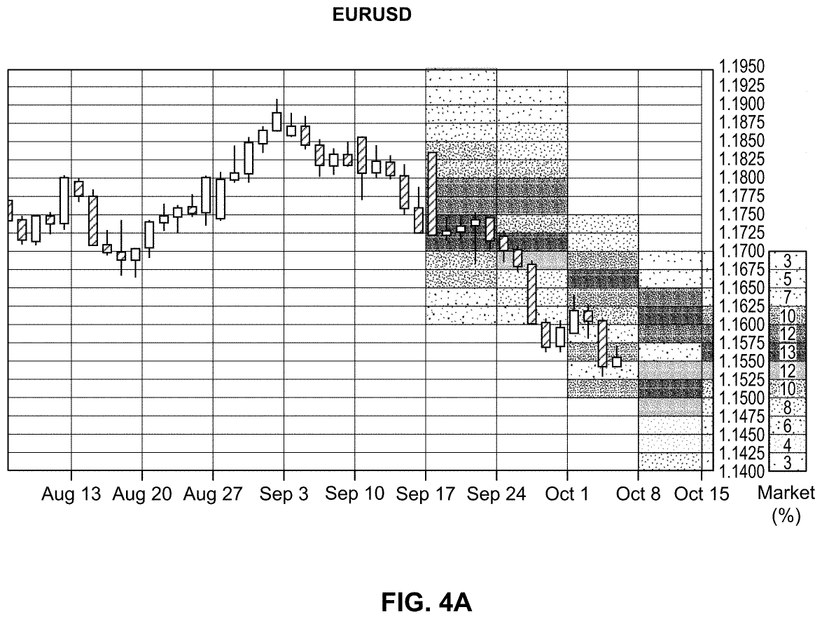

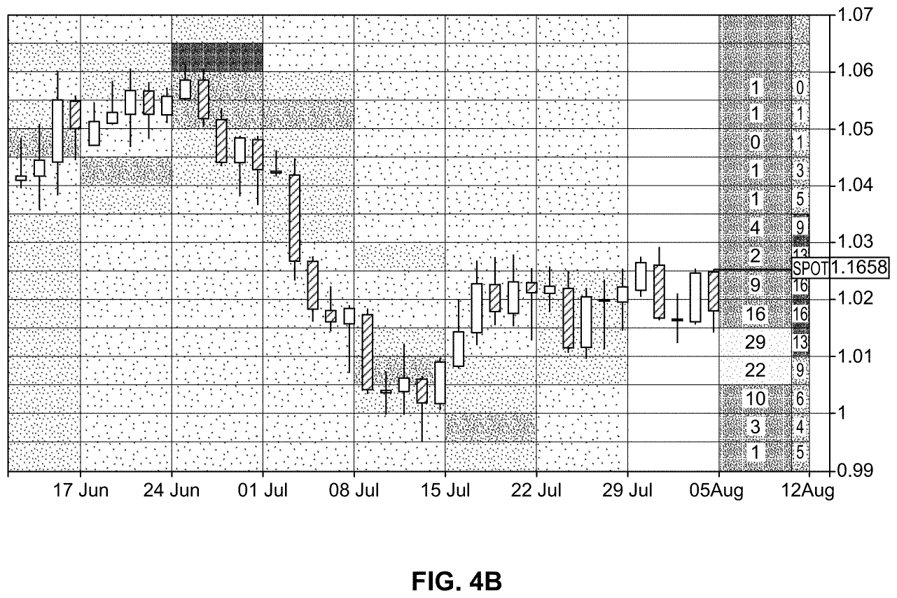

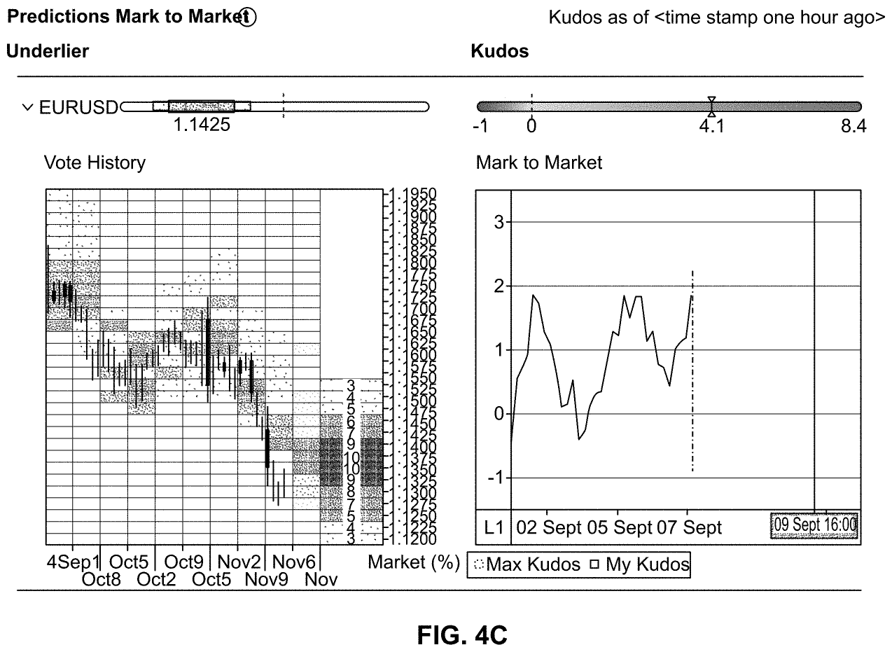

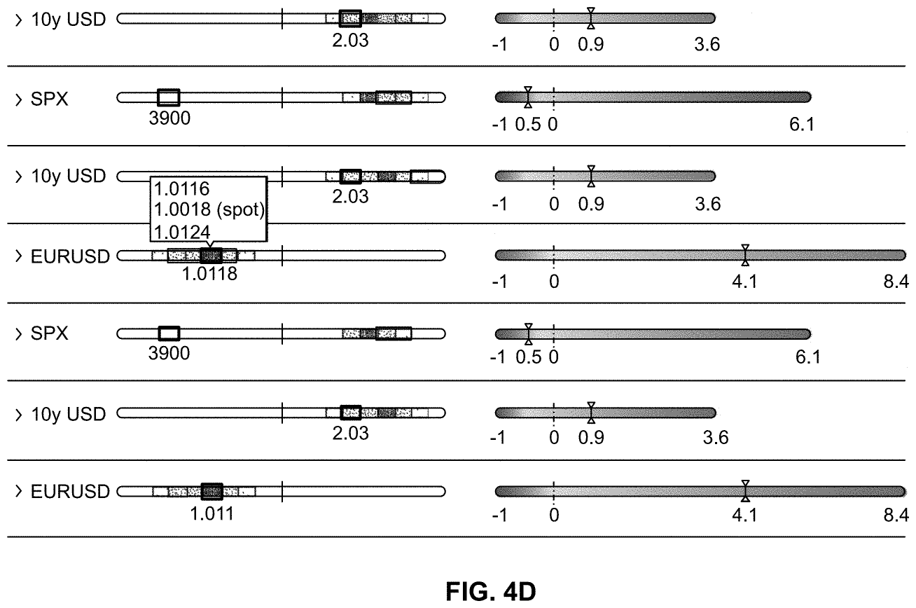

Regardless of how the predictions are obtained for an asset, the polling module 220 aggregates the predictions to generate a distribution of expected prices for the asset in the corresponding time period. In one embodiment, the polling module 220 determines user interface data from the distribution of expected prices and the historical device data. The user interface data may be provided to one or more client devices 140 to drive a price prediction user interface. FIGS. 4A-C illustrate example price prediction user interfaces that may be driven by the data generated by the polling module 220.

In the embodiment shown in FIG. 4A, the price prediction user interface displays the historical price metrics in a candlestick chart showing the minimum, maximum, opening, and closing price for a set of time periods. Other approaches to displaying the historical prices metrics may be used, such as line charts, pop-ups triggered by mouse over or clicks, and overlays/underlays. The user may be able to select the time range for which the price metrics are displayed and the time period may be dynamically adjusted accordingly. For example, if the time range is one month or less, daily price metrics may be displayed, while if the time range displayed is between one month and one year, weekly price metrics may be displayed, and if the time range is greater than one year, monthly price metrics may be displayed. The user may select the time range using any suitable user interface, such as a single or multi-touch input into a graphical user interface (GUI) on a touchscreen of a client device 140. A visual aspect of the candlesticks (in the case of FIG. 4A, whether the body of the candlestick is filled in black or white) may indicate whether the price rose or dropped during that time period. In other embodiments, the historical metrics are displayed in different formats, such as line charts with various interpolation schemes.

Historical distributions of price predictions may be represented in the user interface as an underlay or overlay. In FIG. 4A, the distributions are indicated by intensity of shading at different prices for each week. For the week starting September 17, the majority of users thought the price would remain rangebound and it did (indicated by the intense shading around the actual price of the asset during that week). In the next week, the majority of users thought the price would remain at about the same level or rise a bit, but in fact the price dropped significantly. In the week beginning October 1, the majority of users thought the price would rebound but it do not. In the following week, the users were split roughly evenly between predicting the price would drop further or rebound. The actual price data for this week is not yet available, so it not displayed on the chart. Thus, the chart provides users with insights into how the price has been changing, what other users think is likely to happen, and how accurate user prediction have been for the asset recently, all of which help inform a choice as to whether to buy or sell the asset in the current time period. In some embodiments, the user may be able to drill down into the price prediction distribution to get additional insight (e.g., to see if the users predicting that the price will rebound have been historically more or less accurate than those predicting the price will drop further).

To the right of the historical price data, the user-submitted predictions of where the price will be at the end of the current week may be displayed. The predictions may be generated algorithmically using a pricing function, previously submitted user predictions, or a combination of both. In the embodiment shown in FIG. 4A, the probability of the price being in each of a set of ranges at the end of a current time period (e.g., the current week) is indicated by the shading intensity of a box next to the corresponding price on the y-axis. For example, the most intensely shaded box may indicate the predicted price with the highest probability with lighter shades indicating less likely values. The boxes may also include numerical likelihood (e.g., a percentage) of the price being at the corresponding value at the end of the current time period.

FIG. 4B illustrates an alternative embodiment of the price prediction user interface. In addition to the information displayed by the user interface shown in FIG. 4A, this embodiment also includes indications of the predictions made by other users. The boxes immediately adjacent to the right-hand y-axis scale indicate the probabilities of the price at the end of the current time period, similar to the boxes and numbers on the right of FIG. 4A. Inside of the boxes indicating the likelihood of various prices are a second set of boxes indicating the predictions of other users. These boxes may use shading, numerical values, or both to indicate the number of other users that have made each prediction (e.g., a number may indicate the percentage or raw number of users that have selected a value and the shading may be more intense for popular choices versus less intense for uncommon choices).

FIGS. 4C and 4D illustrate first and second parts, respectively, of an example price prediction user interface that contains information about price predictions and a user's historical accuracy in making predictions. In the example shown in FIG. 4C, the price prediction user interface of FIG. 4B is shown on the left-hand side to provide the user with information about the historical price of the asset and current predictions for the prices at the end of the current time period (e.g., week). On the right-hand side, the price prediction user interface includes a chart of the user's “kudos,” which is a score indicating how accurate the user's prior predictions have been (e.g., a higher kudos corresponds to more accurate historical predictions and vice versa). FIG. 4D, which may be displayed in conjunction with (e.g., below) some or all of the elements shown in FIG. 4C, the user is shown bars corresponding to a set of assets and the user's historical performance in predicting the price of those assets. In one embodiment, the user may click on the bar corresponding to a particular asset to select that asset and the user interface shown in FIG. 4C is updated to provide information about the selected asset.

Referring back to FIG. 2, the trade interface module 230 generates data for driving a user interface with which users can define a derivative. While a few specific examples are described, the user interface is generally applicable to a wide range of derivatives and can be adapted to for any type of derivative without deviating from the principles disclosed. In one embodiment, the trade interface module 230 receives an indication of a type of derivative a user wishes to define from a client device 140 and generates/obtains data to drive the user interface.

In various embodiments, the user interface includes two portions: a historical data portion and a parameter-definition portion. The historical data portion is similar to the user interface generated by the polling module 220 and illustrates the price of an asset that underlies the derivative for a set of prior time periods (e.g., using a candlestick chart). To drive this interface, the interface module retrieves price data for the asset or assets that underly the type of derivative being defined (e.g., from the analytics datastore 260). The parameter-definition portion provides information about the currently defined derivative and provides controls to enable the user to modify one or more parameters of the derivative and see the effect of the modification almost immediately. The trade interface module may assign default values to all of the parameters that are relevant to the selected type of derivative. The default parameters may be global defaults (selected for all derivatives of that type), user defaults (default values selected by or for the user defining the derivative), the most recent parameters used for a derivative of the same type, or selected using any other appropriate technique. For example, in one embodiment, some or all of the default parameters may be selected by a machine learning model (e.g., a neural network) trained to predict likely parameters in view of the user's profile, the user's historical parameter selections, current market conditions, market implied probable or realistic outcomes, or any combination of the preceding or other relevant factors. Alternatively, some or all of the initial parameter values may be specified in the request received from the client device 140. For example, the user may specify parameters using natural language input which is processed to extract the parameters by a natural language processing engine on the client device 140 or analytics server 110.

The trade interface module 230 passes the indication of the type of derivative and the initial parameters to the pricing module 240, which calculates a price for the derivative using the initial parameters. The pricing module 240 may also pre-calculate prices for the derivative using likely alternative values for the parameters. What is considered a likely alternative value for a parameter can be determined by a set of rules, a machine learning model, or a combination of both. For example, a rule might predict that the expiration date for the derivative is likely to be an integer number of weeks from the current date, but is unlikely to be eleven or thirteen days from the current date, so the pricing module 240 calculates prices for derivatives with expiration dates one week, two weeks, three weeks, etc., from the current date. Similarly, a machine learning model may be used to predict what parameter values the user is likely to select in view of the user's historical choices, the type of derivative, and current market conditions. In some embodiments, the pricing module 240 also calculates one or more other metrics for the derivative, such as delta, vega, gamma, and theta values, and provide the capability to solve for terms through mechanisms such as zero-cost structures.

The trade interface module 230 receives the prices generated by the pricing module 240 and provides them along with the other data used to drive the user interface (e.g., historical price data for the underlying assets, any default values selected for parameters, etc.) to the client device 140. As the user interacts with the user interface to modify the value of one or more parameters, the client device 140 may provide the updated values to the trade interface module 230. If the user selects parameter values for which the price has not yet been calculated, the trade interface module 230 may provide the updated parameter values to the pricing module 240, which calculates the price for a derivative with the updated parameters and provides it to the client device 140. While the updated price is being calculated, the user interface may show an estimated price or price range (e.g., using a linear extrapolation from parameter values for which the price has already been calculated) and provide an indication to the user that the currently displayed price is an estimate. Similarly, the pricing module 240 may predict new parameter values that the user is likely to select based on the updated parameter values. For example, if the user has been steadily moving the expiration date to later dates, the pricing module 240 may proactively calculate prices for later expiration dates than were initially calculated.

The implementation module 250 interacts with the trading platform 150 to implement a defined derivative. In one embodiment, an order placement user interface is displayed at a client device 140. The implementation module 250 can provide a user interface that has a portion the same or similar to the user interface provided by the trade interface module 230 to enable the user to define a desired derivative. In response to user selection of a control (or controls) requesting implementation of the desired derivative, the implementation module 250 sends instructions to the trading platform to place an order or orders to implement the desired derivative. In some embodiments, once implementation of the derivative has begun, the order placement user interface may transition to an intra-trade configuration in which the progress of the order or orders is displayed substantially in real time.

Various embodiments of the client devices 140 and user interfaces are described in greater detail below, with reference to FIGS. 3 and 5A through 7C.

In various embodiments, once the derivative parameters have been set to the user's satisfaction, the user can select a control within the user interface to obtain the derivative with either a direct request to the trading platform 150 or by sending a request to the trade interface module 230, which in turn submits a request to the trading platform 150. In some embodiments, the trade interface module 230 can provide users with notifications (e.g., via a push notification, email, or instant message, etc.) if certain criteria relating to the derivative are met. For example, with an RKO or WKO derivative, if the current price is within a pre-specified threshold of a knockout value, the user may be notified so the user can make a decision whether to get out immediately at a loss, or hold on and risk an even greater loss in exchange for the possibility of the price not reaching the knockout price before the expiration of the window. As another example, the user may be notified if the current price crosses a pre-specified contour, such as three or four times the initial investment, so the user can decide whether to exercise an option immediately for a reasonably large profit or gamble on earning an even greater profit by waiting.

The analytics datastore 260 includes one or more computer-readable media that store data used by the analytics server 110. For example, the analytics datastore 260 may include copies of the historical price data, price predictions, and derivative prices used to drive the various user interfaces provided by the analytics server 110. The analytics datastore 260 may also include other data used the analytics server 110, such as user profile data indicating the preferences (e.g., default parameters) of users, historical data regarding derivatives defined by users, one or more derivatives for which the user is designated to provide price predictions, and the like. Although the analytics datastore 260 is shown as a single entity within the analytics server 110, this functionality may be provided by multiple datastores, some or all of which may be physically separated from the analytics server 110 and accessed via the network 170.

FIG. 3 illustrates one embodiment of a client device 140 that may be used to interact with the analytics server 110. In the embodiment shown, the client device includes a trading app 310 and a local datastores 320. In other embodiments, the client device 140 includes different or additional elements. In addition, the functions may be distributed among the elements in a different manner than described.

The trading app 310 is software that executes on the client device 140 to enable interaction with the analytics server 110. The trading app 310 may include a communications module 312 and a rendering engine 314. The communications module 312 sends requests for data to the analytics server 110 over the network 170 and receives/processes data and requests received from the analytics server. The rendering engine 314 causes the client device 140 to display various user interfaces driven by data provided by the analytics server 110 and determines if additional data is required to service user requests. The rendering engine 314 may interact with or be executed by one or more graphics processing units (GPUs) to generate the user interfaces. The local datastore 320 includes one or more computer-readable media that store the data used by the client device 140. For example, the local datastore 320 may include cached copies of historical price data and derivative pricing data received from the analytics server 110.

In various embodiments, a user opens the trading app 310 and may select a user interface to initiate from a menu. For example, the user may initiate a polling user interface to provide predictions for future prices of any assets for which the user is designated to provide such predictions. As another example, the user may initiate a price prediction distribution user interface to select an asset and view historical price data and price prediction distributions (such as the example user interface shown in FIG. 4). As a further example, the user may initiate a derivative-definition user interface to explore options for a derivative and obtain a derivative with selected parameters if desired.

In one embodiment, a user initiates the derivative-definition user interface by selecting a type of derivative to define, such as by selecting it from a drop down list (e.g., a list of favorites or recently defined derivative types) or typing a possibly partial definition of the derivative type into a text box. In the latter case, natural language processing may be used to identify what type of derivative the user wants to define. Assuming that the relevant data is not already available at the client device 140 (e.g., it is not cached in the local datastore 320), the communications module 312 sends a request to the analytics server 110 identifying one or more underlying assets and the type of derivative. The derivative the pricing module 240 initially provides historical price data for the underlying asset or assets, pricing data for the derivative using a default parameter set, and, optionally, pricing data for one or more additional parameter sets that are likely to be selected by the user. Furthermore, the pricing module 240 may continue to generate pricing data for additional parameter sets and provide it to the communications module 312.

The rendering engine 314 causes the client device 140 to display the selected user interface. In the case of the derivative-definition user interface, instead of the pricing module 240 of the analytics server 110 determining what parameter values the user is likely to select, the rendering engine 314 may make these determinations (using the same or similar techniques to those described above with reference to the pricing module 240 or approximations, such as a Taylor expansion or interpolation techniques) and request the relevant pricing data from the analytics server 110.

As described previously, the derivative-definition user interface may include a historical price portion and a parameter-definition portion. The historical price portion includes a chart (e.g., a candlestick chart or line chart) of the historical price of one or more underlying assets. The historical price portion may also include a representation of a price prediction distribution generated by the polling module 220. The historical data portion may further include additional overlays/underlays conveying other information, such as the price of other assets, the occurrence of significant events that may have impacted the price of the asset, or any other information that may be useful to the user to contextualize the historical price data. Examples of information that may be conveyed by overlays/underlays include the occurrence of important macro-economic events, such as non-farm-payroll publications, interest rate meetings, company earnings, or other economic or asset-specific announcements; technical indicators, including moving average, relative strength index, volumes traded, activity by client segment, etc.; and derivatives pricing information, such as market implied probabilities, percentile ranks for prices of at-the-money options, etc.

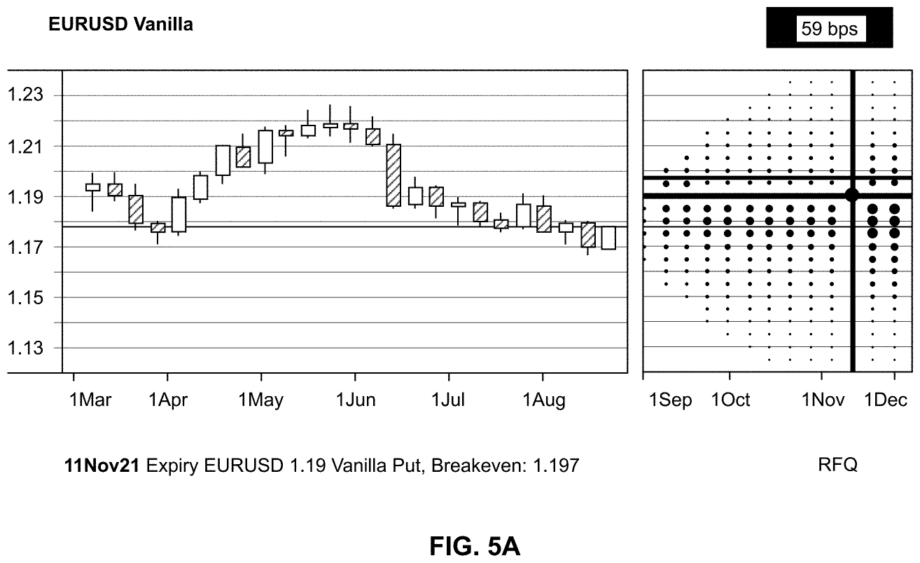

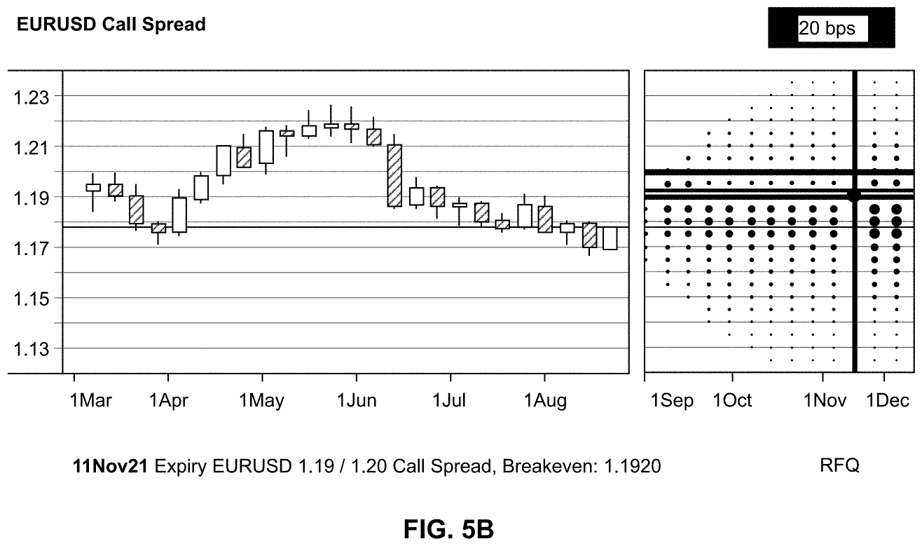

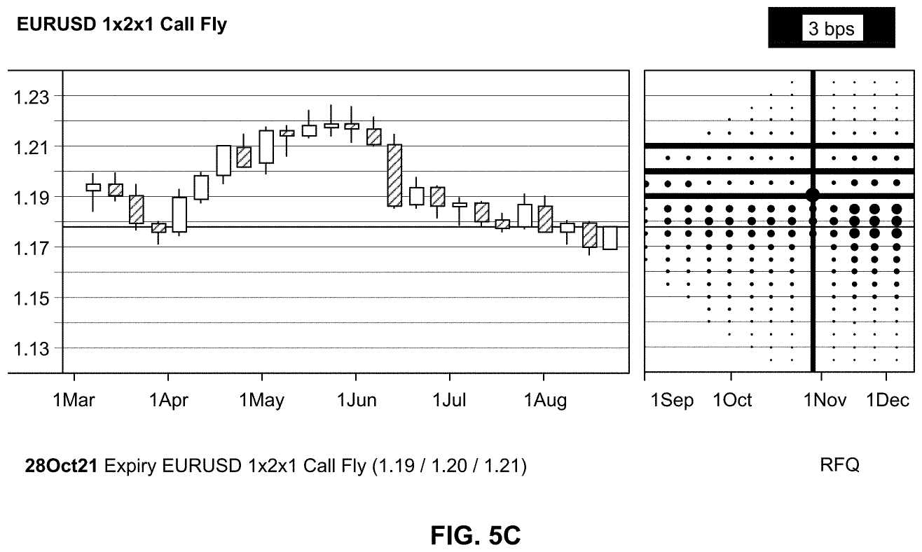

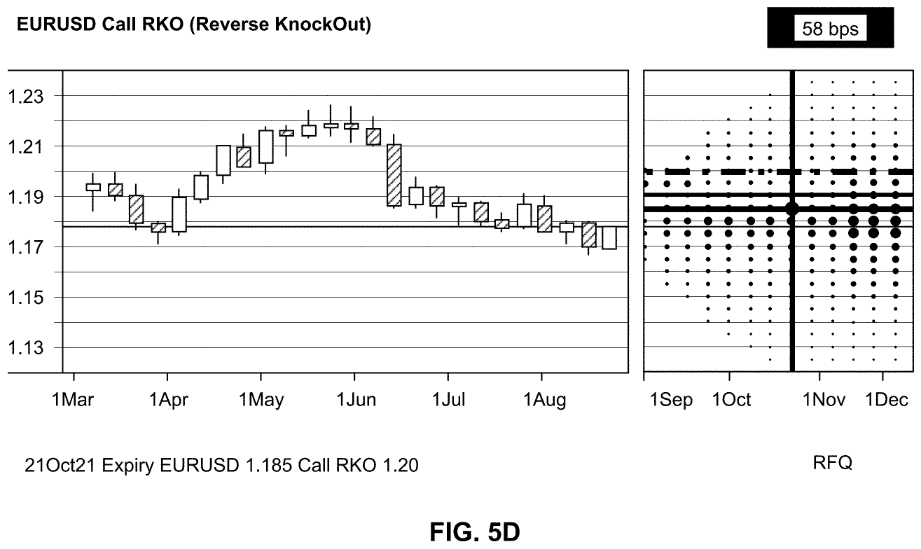

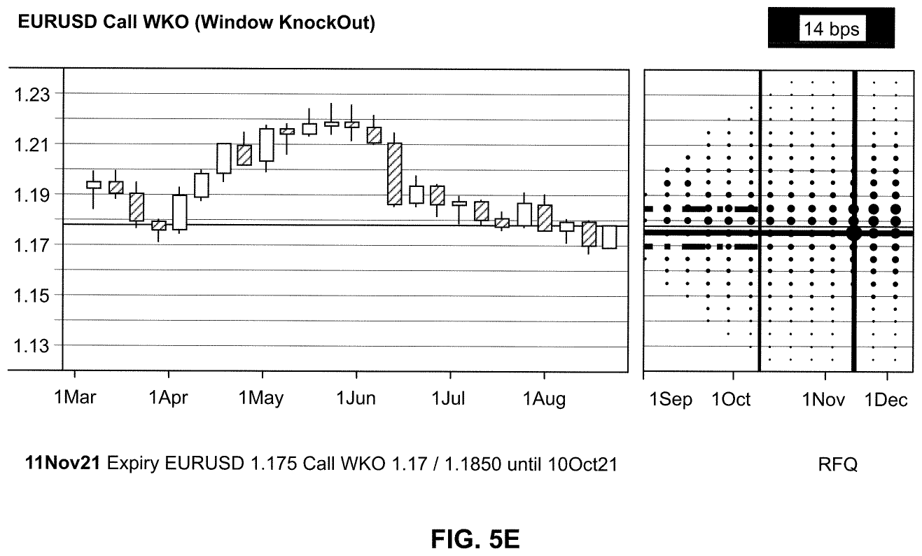

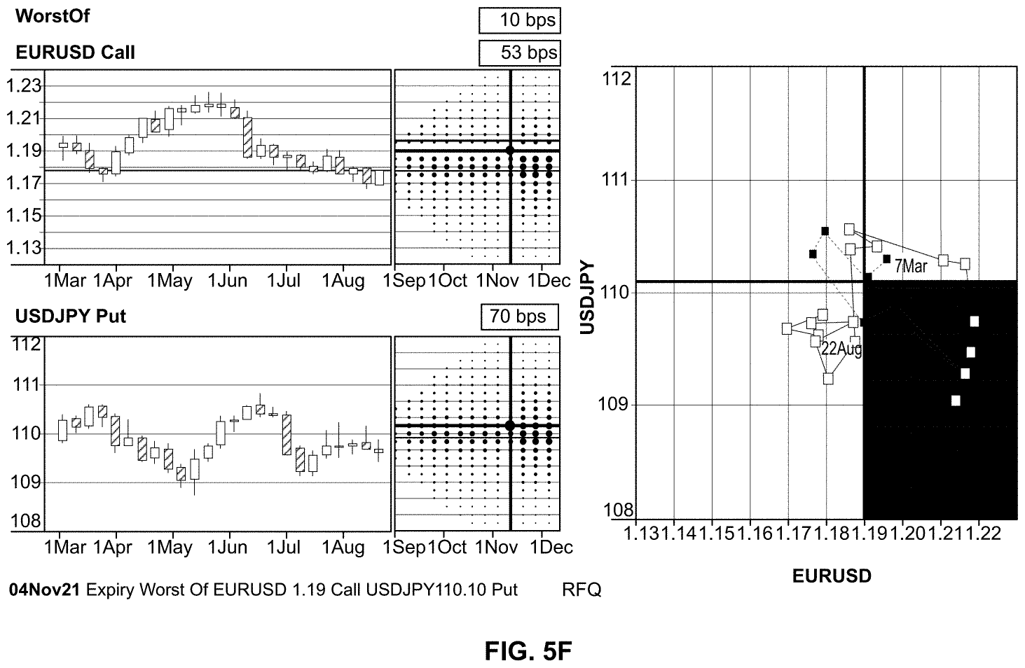

The parameter-definition portion provides a visual representation of the current parameter values on corresponding scales or axes. The user may modify a parameter value by interacting with the corresponding visual representation, such as by clicking or holding a finger on the representation and dragging it to a different position. The parameter-definition portion may also include overlays/underlays providing various information, such as contours representing rates of return for different asset prices over time, vertical lines (or other indicators) of expected events that will impact price/rate of return (e.g., dates on which interest rate changes are expected to be announced, etc.), estimated probabilities of asset price over time, etc. FIGS. 5A through 5F illustrate using an example parameter-definition user interface to set parameters for various types of derivatives.

FIG. 5A illustrates defining a vanilla put option for the EURUSD currency pair. On the left, the weekly value of EURUSD for the preceding six months is illustrated. On the right, a first horizontal line indicates the asset spot price (1.179), a second horizontal line indicates the strike price of a put option (1.190), and a third horizontal line indicates the break-even price of the structure (1.197). A vertical line indicates the expiration date of the put option. The various lines can be visually distinguished using variations in one or more visual properties, such as color, dash pattern, and thickness. For example, the put price may be indicated by a solid line in a first color (e.g., green) while the asset spot price may be indicated by a thinner or dashed line in the same or a different color (e.g., gray). The user can modify the put price by dragging the corresponding line up or down, and the other parameter values are automatically updated (e.g., the break-even point is recalculated automatically without additional user input and the corresponding line is moved accordingly).

In the embodiment shown, the parameter-definition portion has an overlay that displays dots for different combinations of price and expiration date. The dots vary in various visual attributes, such as color and size. The sizes of the dots may correspond to vanilla premiums at each level. The colors of the dots may represent how cheap or expensive that option is versus its own history (e.g., green if the 3m 1% otms call in EURUSD is in the 5th percentile versus the last two years). Note that in this case skew is visible because it results in the dots being larger on one side of the asset spot or forward price versus the other (visually appearing closer to you if the surface is bid for calls).

FIG. 5B illustrates a version of the user interface for defining the parameters of a EURUSD call spread. The upper and lower strike prices are represented by a pair of horizontal lines that may be visually distinguished (e.g., displayed in different colors), both of which the user may move to different positions to change the corresponding value. Similarly, FIG. 5C adds a little more complexity, representing a call fly, so three are now vertical three lines that the user can move to set each of the strike prices. As with FIG. 5A, if one of the vertical lines in FIG. 5B or 5C is moved, any impacted parameter values are automatically updated, and the UI updated accordingly.

FIGS. 5D and 5E illustrate versions of the user interface for a call RKO and call WKO, respectively. There are now two vertical lines. One to set the expiration date and another to set the end of the knockout window. There are also one (RKO) or two (WKO) vertical lines (in this case, dashed) indicating the knockout prices. All of these lines can be repositioned by the user to tailor the derivative to their preferences (and impacted parameters will be automatically updated accordingly, as before). These examples provide a particularly strong example of the power of the user interface. By displaying the historical price data for the underlying asset in conjunction with a visual representation of the knockout prices and length of the window, the user may better estimate the likelihood that the asset price will reach one of the knockout prices during the window. Furthermore, the user can manage the trade on an on-going basis, restructuring the trade if desired.

FIG. 5F illustrates a version of the user interface where there are two underlying assets. The user can modify the parameters relating to each underlying asset by repositioning the lines and impacted parameter values are updated automatically, as with the other examples. In this case, the user interface includes an additional portion that shows a two-dimensional surface representing the values of both assets and plots the historical price of the pair of assets moving around the surface, with higher opacity lines indicating more recent price levels. Thus, the user may better estimate the likelihood that the combination of asset prices will be in the profitable region of the surface (in this case, the bottom-right quadrant) based on the historical price momentum. In some embodiments, the implied probabilities of the combination of asset prices having particular values on a target date may be calculated displayed using an overlay.

Additional or alternative overlays/underlays may be included in the parameter-definition portion of the user interface. For examples, a pixelated histogram of probabilities of spot landing in each discrete box (defined by date and spot range), payout ratios, evolution of Greeks (e.g., theta decay), market implied probabilities, costs of alternate implementations, open interest in equivalent listed market, scenario-based profit and loss (PnL) (e.g., stock market up and down in spot and vol), expected events (e.g., dates that interest rate changes are scheduled to be announced or other events that may impact asset price), etc. As another example, payout contours may be overlaid on the parameter-definition portion. The contours represent multiples of premium over time for different levels of spot and as time progresses. As the user modifies the parameters, the contours may be automatically recalculated and updated. In one embodiment, the contours for likely parameter sets may be pre-calculated (e.g., by the pricing module 240 of the analytics server 110) to reduce lag in the update process.

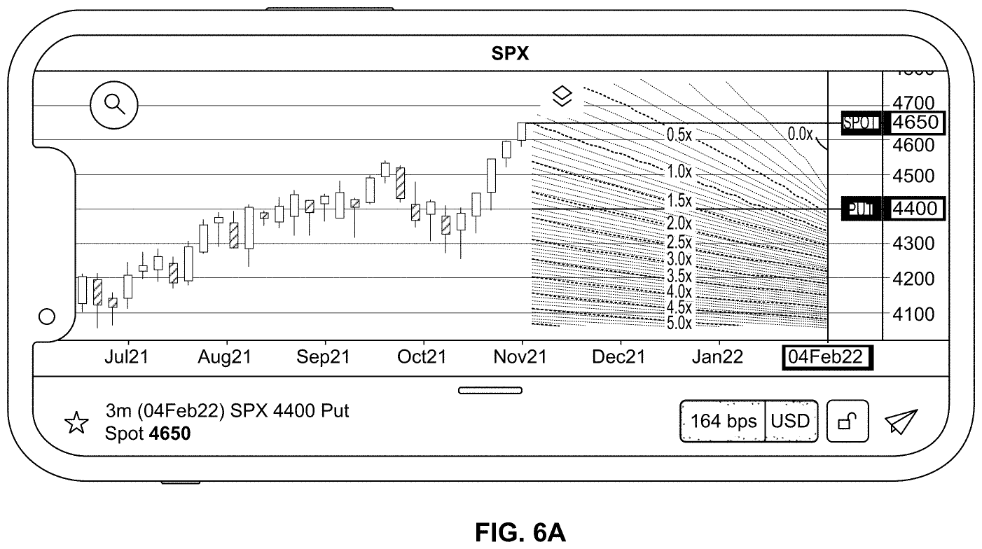

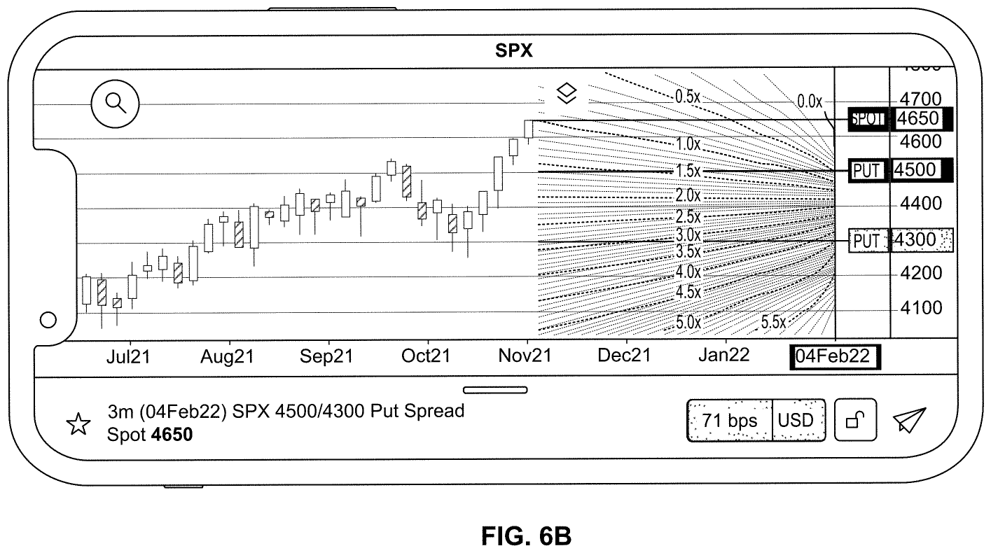

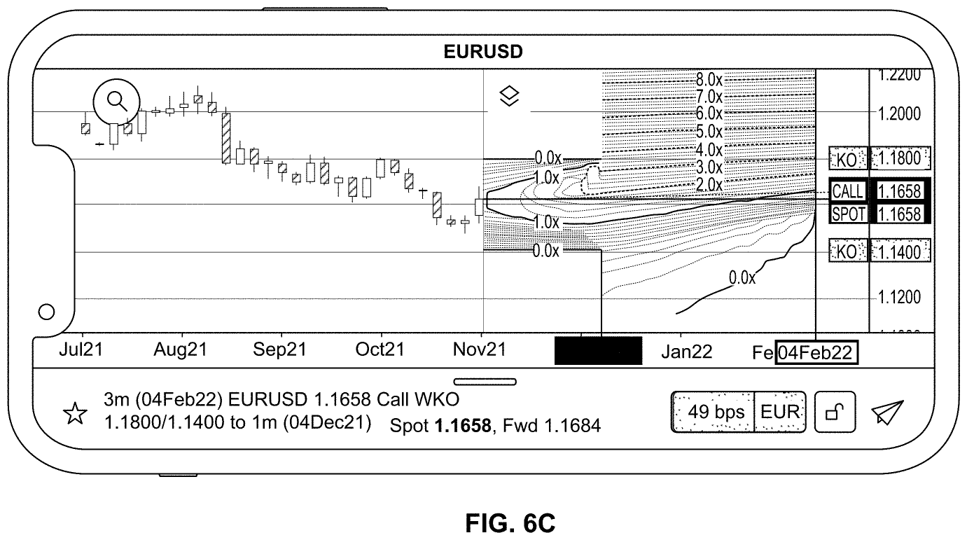

FIGS. 6A through 6C illustrate an example user interface being displayed by a smartphone that includes a contour overlay. In FIG. 6A, the user interface is being used to define a put. The contours indicate the relative return on investment if the put is exercised at various times and at various prices of the underlying asset. Contours corresponding to a profit may be shown in one color (e.g., green) while contours corresponding to a loss may be displayed in a different color (e.g., red), while the break-even contour may be displayed in a third color (e.g., yellow). Thus, the user can quickly and easily estimate the likelihood that the underlying asset will be in a profitable range at some point before the expiration period and how much risk of loss is associated with the put. In this case, making a significant profit on the put seems unlikely unless the user is expecting a significant reduction in the price of the underlying asset.

In FIG. 6B, the user interface is being used to define a put spread. Here, the range of prices for the underlying asset that are profitable have been increased, indicated by the green contoured regions occupying a greater proportion of the user interface. Thus, the user can intuitively compare the put and put spread options.

In FIG. 6C, the user interface is being used to define a call WKO. The contours indicate that if the user successfully navigates the window, then being above the strike at any time can provide potentially many multiples of the original investment. Furthermore, the user can adjust the knockout values or length of the window in view of the displayed historical data until the user is satisfied that the risk of hitting one of the knockout values is sufficiently low. The user can also instantly see how these adjustments affect the potential payout if the window is successfully navigated, enabling an intuitive balancing of the risks and rewards.

In the embodiment shown in FIGS. 6A through 6C, the user interface also includes a lock button which may be used to lock the value of one or more parameters. If a parameter is locked, then when the user adjusts the value of another parameter, the values of the remaining unlocked parameters will also be adjusted automatically without further user input to maintain the value of the locked parameter. For example, the user may lock price at zero for a costless collar strategy. As the strike is moved for one leg, the other updates automatically to keep the cost at zero.

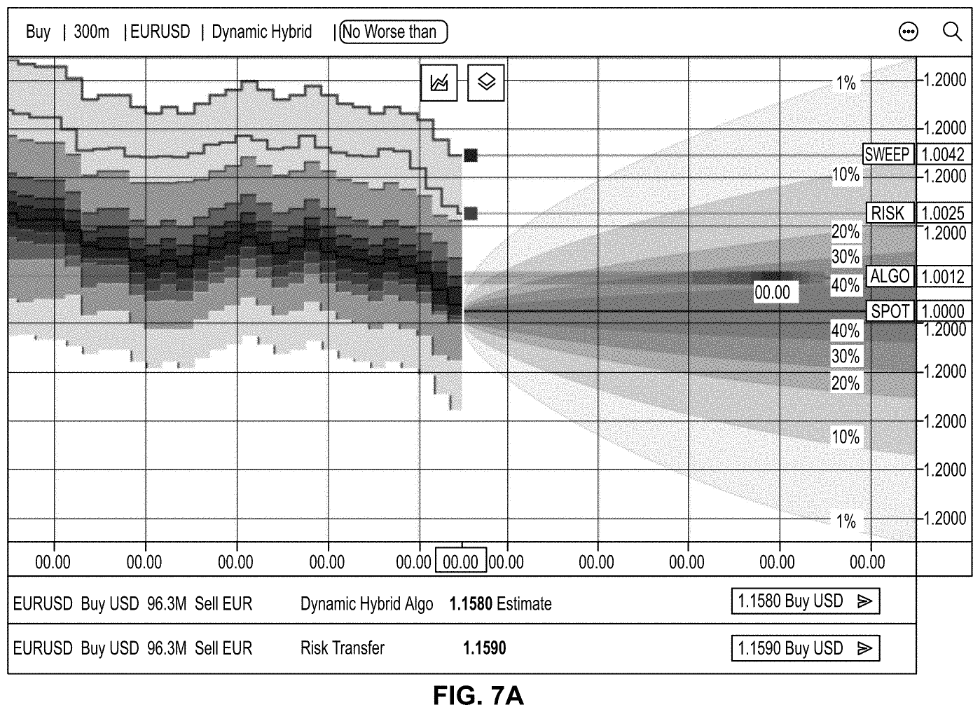

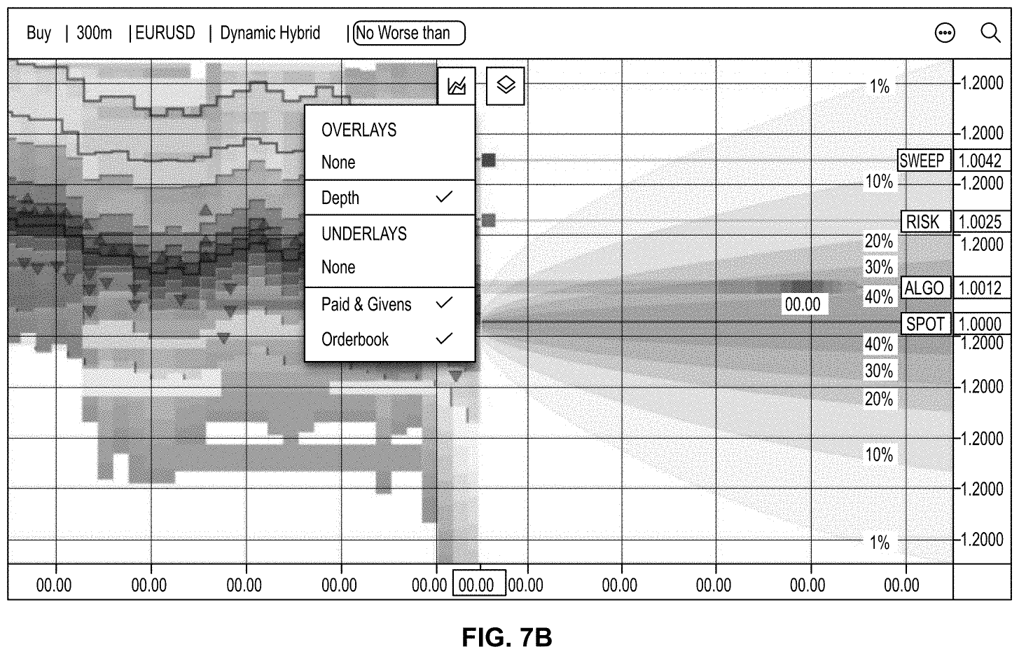

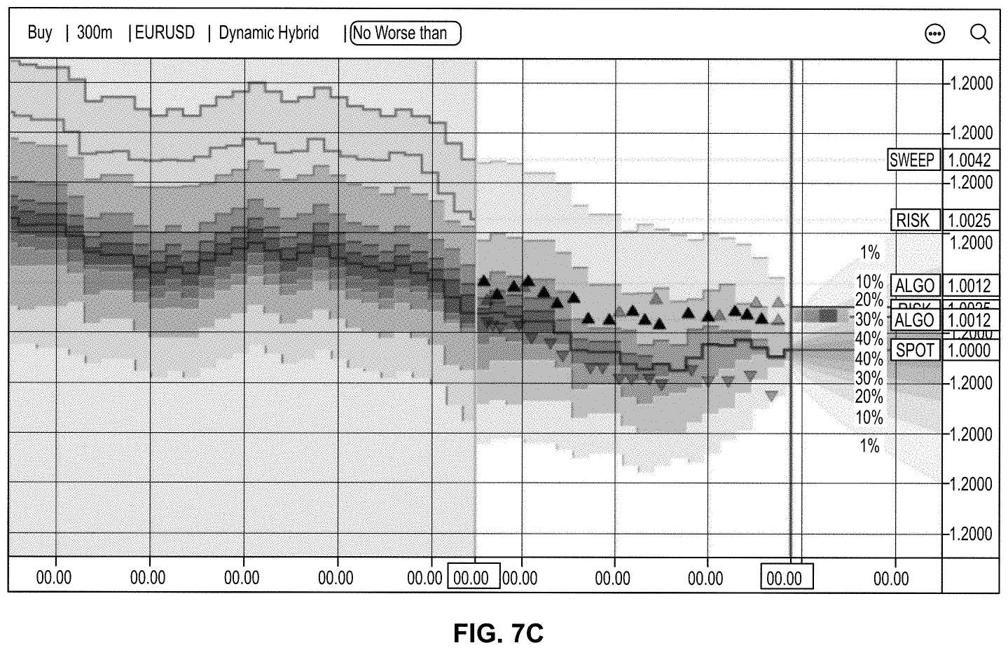

FIGS. 7A through 7C illustrate an example order placement user interface. In the embodiment shown, the orders relate to a EURUSD derivative, but it should be appreciated that the illustrated principles may be used to define orders for a wide range of derivatives. In FIG. 7A, historical price data for the derivative is shown on the left of the user interface. On the right, contours are displayed as an overlay indicating the likelihood of the spot price being in various ranges over time. Thus, the user can quickly obtain an intuitive estimation of the risks and rewards associated with trades using different parameters. The order placement user interface includes controls to enable the user to place orders using one or more execution methods (in the case of FIG. 7A, two methods are available: one using a dynamic hybrid algorithm and the other using a risk transfer approach). The user may execute one of these methods by clicking or otherwise selecting the corresponding control.

FIG. 7B illustrates that the order placement user interface can be customized to include or omit various overlays and underlays. In the example shown, the user has selected to include a depth overlay and both paid & givens and orderbook underlays. It should be appreciated that a wide range of underlays and overlays may be defined in a modular fashion to present available information to the user in the user interface.

FIG. 7C illustrates the transition of the order placement user interface to an intra-trade mode after the user has requested execution of a method to implement a defined derivative. As in FIG. 7A, the left side of the user interface displays historical price data for the derivative. The middle portion of the user interface is an intra-trade portion that displays how the price has evolved since execution was requested and includes visual indications of any executed fills and price actions. The visual indications may be geometric shapes (e.g., triangles) placed at a position on the x-axis corresponding to the time at which the action occurred and a position on the y-axis corresponding to a price at which the action was performed. The right-hand side of the user interface continues to display the predicted/estimated likelihood of various values of the derivative in future, similar to FIG. 7A.

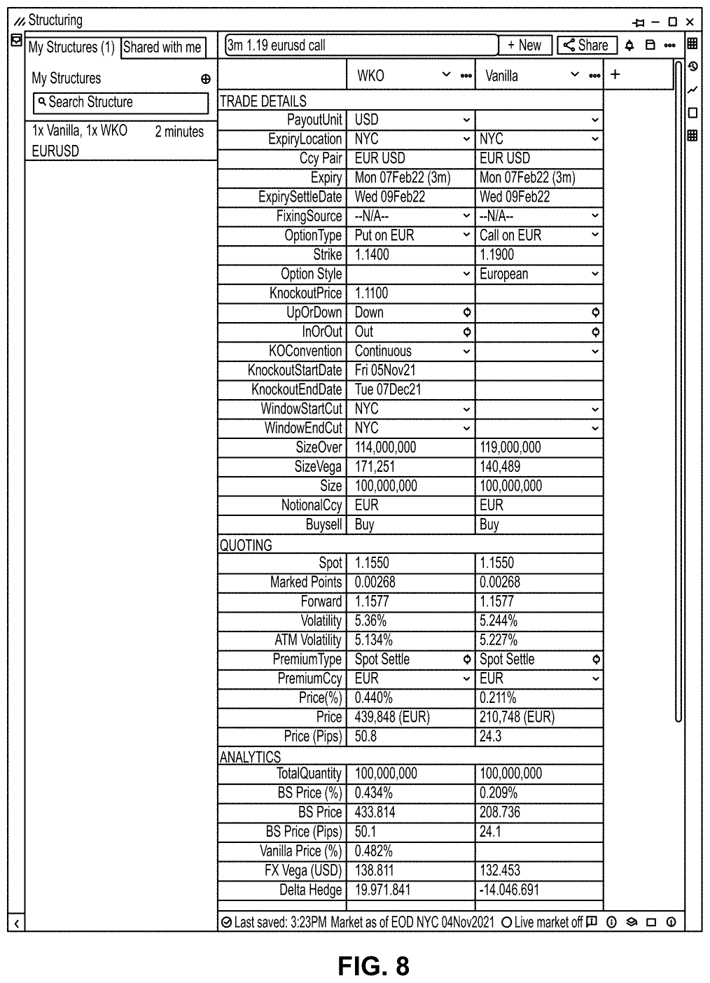

FIG. 8 illustrates the improvement that the user interfaces of FIGS. 5A through 7C represent over more conventional approaches. FIG. 8 shows a portion of a spreadsheet interface displaying parameters for a WKO and a vanilla put option. This interface contains basic information such as strike and spot prices, expiration dates for the option, and values and expiration dates of any knockout windows. However, it completely lacks the contextual information of the historical price data, the additional information provided by the various underlays and overlays, or the intuitive visualization of how the various values interrelate. Further, the information does not comfortably fit on a regular computer monitor without the need for a scroll bar, in contrast to the user interfaces of FIGS. 5A through 7C which can be comfortably displayed on a smartphone screen. In short, the disclosed user interfaces provide a significant improvement over prior systems by enabling a much larger amount of information to be displayed in a small amount of screen real estate in an intuitive manner.

### Example Methods

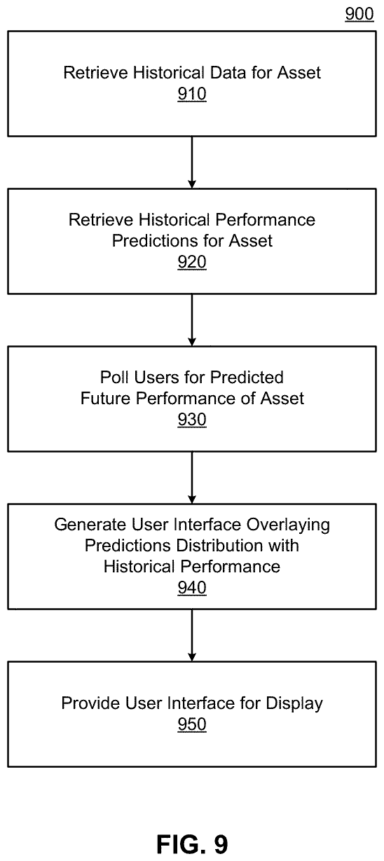

FIG. 9 illustrates a method 900 for generating an information-dense user interface with historical price data for an asset overlaid with a price prediction distribution, according to one embodiment. The steps of FIG. 9 are illustrated from the perspective of the analytics server 110 performing the method 900. However, some or all of the steps may be performed by other entities or components. In addition, some embodiments may perform the steps in parallel, perform the steps in different orders, or perform different steps.

In the embodiment shown, the method 900 begins with the analytics server 110 retrieving 910 historical data for an asset. The historical data includes price data for the asset over a time range, such as one month, six months, or one year, etc. The time range is divided into multiple time periods, such as days, weeks, or months, etc. The historical data may include the maximum, minimum, starting, and closing price for the asset in some or all of the time periods within the time range. Alternatively, the historical data may be raw prices and the analytics server 110 may divide the historical data into buckets corresponding to predetermined time periods and calculate the maximum, minimum, starting, and closing price for each time period.

The analytics server 110 retrieves 920 historical performance predictions for the asset. The performance predictions include predictions of the asset price for time periods made by users in advance of those time periods. The analytics server 110 also polls 930 users for predictions of the future performance of the asset. The analytics server generates 940 a user interface that overlays the historical data with an indication of the distribution of the historical predictions (e.g., in a candlestick plot as shown in FIGS. 4A-C). The user interface may also indicate a probability distribution of future prices, the kudos value to the user in correctly predicting future values, a kudos value that may be lost if the user predicts incorrectly, a distribution of predictions made by other users, or any other combination of information useful to the user. The analytics server 110 provides 950 the user interface for display (e.g., at a client device 140). Thus, a user can compare the historical predictions to the corresponding historical prices to evaluate how reliable the predictions of future performance are likely to be.

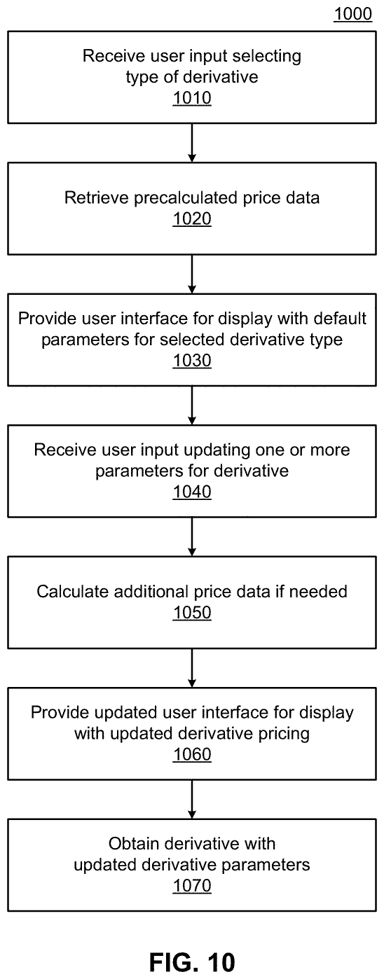

FIG. 10 illustrates a method 1000 for updating parameters of a transaction using an information-dense user interface, according to one embodiment. The steps of FIG. 10 are illustrated from the perspective of the analytics server 110 performing the method 1000. However, some or all of the steps may be performed by other entities or components. In addition, some embodiments may perform the steps in parallel, perform the steps in different orders, or perform different steps.

In the embodiment shown, the method 1000 begins with the analytics server 110 receiving 1010 an indication of user input selecting a type of derivative to be defined. The user may have selected the type of derivative using a client device 140, which provides the selection to the analytics server 110 via the network 170. The analytics server 110 retrieves 1020 precalculated price data for the derivative type. The precalculated price data may be for a derivative of the selected type with default parameters, which may be hard coded, provided by the user as preferences, the previous parameters used by the user for the same type of derivative, or determined using a model (e.g., a machine learning model) based on current market conditions, information about the user, or both. The analytics server 110 may periodically (e.g., hourly, daily, etc.) calculate prices for derivatives of one or more types with default parameters. In some embodiments, the analytics server 110 may compute terms and price for the derivative on the fly to resolve any parameters not entered. For example, if the user does not enter a strike price, the analytics server 110 may compute at-the-money strike and price accordingly. The analytics server 110 may also query or compute all associated pricing data, e.g. price, sensitivities, contour information, etc.

The analytics server 110 provides 1030 a user interface for display using the precalculated price data. The user interface may include a visual representation of the default parameters and a price determined from the price data (e.g., as shown in FIGS. 5A through 6C). The analytics server 110 receives 1040 an indication of user input updating one or more of the parameters of the derivative. For example, the user may move the line presenting a price or expiration date in the user interface on a client device 140, which sends the values for the updated parameters to the analytics server 110.

The analytics server 110 determines whether there is already precalculated price data for a derivative with the updated parameters. If not, the analytics server 110 calculates 1050 additional price data using the updated parameters. The analytics server 110 provides 1060 an updated user interface for displaying the updated derivative pricing. Alternatively, the analytics server 110 may proactively provide additional precalculated pricing data for parameter values that the user is likely to select to the client device 140. Thus, the client device 140 may not request additional pricing information when the user updates one or more parameters as the relevant pricing data may already be available at the client device 140.

This process may be iterated, with the user continuing to update the parameters and receive updated pricing data. Once the user is satisfied with the derivative parameters, the user may request to obtain 1070 the defined derivative (e.g., by selecting a button in the user interface). The analytics server 110 receives an indication of the user's intent to obtain 1070 the derivative from the client device 140 and obtains 1070 the derivative (e.g., by placing an order with the trading platform 150). Alternatively, the client device 140 may place an order for the derivative with the trading platform 150 directly.

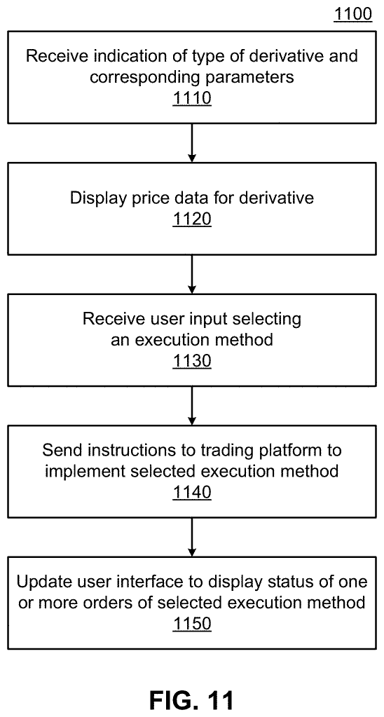

FIG. 11 illustrates a method 1100 for placing one or more orders to implement a derivative using an information-dense user interface and receiving intra-trade updates regarding progress of the orders, according to one embodiment. The steps of FIG. 11 are illustrated from the perspective of the analytics server 110 performing the method 1100. However, some or all of the steps may be performed by other entities or components. In addition, some embodiments may perform the steps in parallel, perform the steps in different orders, or perform different steps.

In the embodiment shown, the method 1100 begins with the analytics server 110 receiving 1110 an indication of a type of derivative and the corresponding parameters. For example, the user may use an approach similar to that described with reference to FIG. 10 to define a desired derivative and obtain pricing data for the desired derivative. The price of the derivative may be displayed 1120 in the user interface.

The analytics server 110 receives 1130 user input selecting an execution method. For example, the user may click on or otherwise select a button to implement a desired execution method. As shown in FIG. 7A, the user interface may include buttons (or other controls) for selecting between multiple possible execution methods. On selection of an execution method, the analytics server 110 sends 1140 instructions to a trading platform 150 to implement the selected execution method by placing one or more orders. The user interface may be updated 1150 to display the status of the placed orders (e.g., visual indicators of executed fills and price actions of the placed orders may be displayed in the user interface, as shown in FIG. 7C). Once the orders have been completed, the user interface may be updated accordingly to indicate the derivative has been implemented and update the user on any profit or loss that results.

### Computing System Architecture

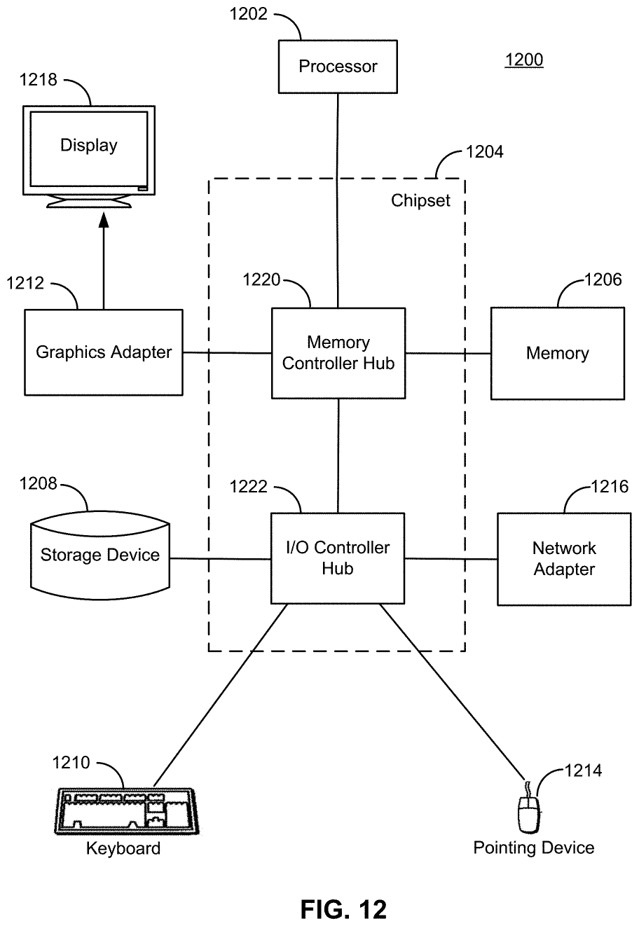

FIG. 12 is a block diagram of an example computer 1200 suitable for use as an analytics server 110, client device 140, or trading platform 150, etc. The example computer 1200 includes at least one processor 1202 coupled to a chipset 1204. The chipset 1204 includes a memory controller hub 1220 and an input/output (I/O) controller hub 1222. A memory 1206 and a graphics adapter 1212 are coupled to the memory controller hub 1220, and a display 1218 is coupled to the graphics adapter 1212. A storage device 1208, keyboard 1210, pointing device 1214, and network adapter 1216 are coupled to the I/O controller hub 1222. Other embodiments of the computer 1200 have different architectures.

In the embodiment shown in FIG. 12, the storage device 1208 is a non-transitory computer-readable storage medium such as a hard drive, compact disk read-only memory (CD-ROM), DVD, or a solid-state memory device. The memory 1206 holds instructions and data used by the processor 1202. The pointing device 1214 is a mouse, track ball, touchscreen, or other type of pointing device, and may be used in combination with the keyboard 1210 (which may be an on-screen keyboard) to input data into the computer system 1200. The graphics adapter 1212 displays images and other information on the display 1218. The network adapter 1216 couples the computer system 1200 to one or more computer networks, such as network 170.

The types of computers used by the entities of FIGS. 1 through 3 can vary depending upon the embodiment and the processing power required by the entity. For example, the market data datastore 130 might include multiple blade servers working together to provide the functionality described. Furthermore, the computers can lack some of the components described above, such as keyboards 1010, graphics adapters 1012, and displays 1018.

### Additional Considerations

The above description focuses on the technical details of an information-dense user interface for efficiently presenting various information to users. It does not focus on, nor represent, how certain specific embodiments may be implemented in compliance with any relevant regulatory requirements. Specific embodiments would consider and be compliant with any relevant financial and other regulations of the jurisdiction or jurisdictions in which the user interface will be used.

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs of a system and process for providing an information-dense user interface. Thus, while particular embodiments and applications have been illustrated and described, it is to be understood that the described subject matter is not limited to the precise construction and components disclosed. The scope of protection should be limited only by the following claims.

What is claimed is:

1. A method of defining parameters of a derivative in an information-dense user interface, the method comprising:
providing for display the information-dense user interface, the information-dense user interface including a historical data portion and a parameter-definition portion, wherein the historical data portion depicts historical price data for the derivative and the parameter-definition portion includes visual representations of the parameters positioned to indicate default values for the parameters of the derivative;
receive user input moving a first visual representation of the visual representations that corresponds to a first parameter of the parameters from an initial position to an updated position, the initial position indicative of a default value of the first parameter and the updated position indicative of an updated value of the first parameter;
determining updated values of one or more additional parameters of the derivative using the updated value of the first parameter; and
updating the information-dense user interface to include the updated values of the one or more additional parameters for the derivative.

2. The method of claim 1, wherein the parameter-definition portion further includes a set of contours indicating an expected profit or loss of the derivative at future times based on corresponding future prices of the derivative.

3. The method of claim 1, wherein the first visual representation comprises a substantially horizontal line and the first parameter is a price associated with the derivative, and moving the first visual representation comprises moving the substantially horizontal line from a first y-coordinate corresponding to a first value of the price to a second y-coordinate corresponding to a second value of the price.

4. The method of claim 3, wherein the price associated with the derivative is one of a put price, a spot price, an upper knock out price, a lower knock out price, or a strike price.

5. The method of claim 1, wherein the first visual representation comprises a substantially vertical line and the first parameter is a time associated with the derivative, and moving the first visual representation comprises moving the substantially vertical line from a first x-coordinate corresponding to a first time to a second x-coordinate corresponding to a second time.

6. The method of claim 5, wherein the time associated with the derivative is one of an expiration date, a start time for a lower knockout price, an end time for the lower knockout price, a start time for an upper knockout price, or an end time for the upper knockout price.

7. The method of claim 1, further comprising:
receiving user input indicating a type of derivative; and
retrieving precalculated price data for the type of derivative from a datastore, wherein the information-dense user interface further comprises an initial price for the derivative determined from the precalculated price data.

8. The method of claim 7, wherein determining the updated price for the derivative comprises interpolating the updated price from the precalculated price data.

9. The method of claim 1, further comprising placing one or more orders to implement the derivative.

10. The method of claim 1, further comprising receiving an indication that a user has selected a lock control in the information-dense user interface that locks a value of a locked parameter of the additional parameters, wherein determining the updated values of one or more additional parameters of the derivative comprises calculating updated values for other ones of the additional parameters without changing the value of the locked parameter.

11. The method of claim 10, wherein the locked parameter is a cost to obtain the derivative.

12. A method of implementing a derivative using an information-dense user interface, the method comprising:
providing for display the information-dense user interface, the information-dense user interface including a parameter-definition portion and one or more controls for initiating one or more execution methods, wherein the parameter-definition portion includes visual representations of parameters of the derivative that are movable, in response to user input, to define values for the parameters of the derivative;
receive user input via the one or more controls requesting initiation of a selected execution method of the one or more execution methods; and
submitting one or more orders to a trading platform to implement the selected execution method.

13. The method of claim 12, wherein the user interface further comprises a historical data portion that depicts historical price data for the derivative.

14. The method of claim 12, wherein the parameter-definition portion further includes a set of contours indicating probabilities that a price of the derivative will be in corresponding ranges at future times.

15. The method of claim 12, wherein the first visual representation comprises a substantially horizontal line and the first parameter is a price associated with the derivative, and moving the first visual representation comprises moving the substantially horizontal line from a first y-coordinate corresponding to a first price to a second y-coordinate corresponding to a second price.

16. The method of claim 12, wherein the first visual representation comprises a substantially vertical line and the first parameter is a time associated with the derivative, and moving the first visual representation comprises moving the substantially vertical line from a first x-coordinate corresponding to a first time to a second x-coordinate corresponding to a second time.

17. The method of claim 12, wherein the user interface further comprises an intra-trade portion that indicates progress of the one or more orders, the intra-trade portion including one or more visual indications of executed fills or price actions.

18. A method of generating an information-dense user interface with historical price data for an asset and a price prediction distribution, the method comprising:
retrieving historical price data for the asset;
retrieving historical performance predictions for the asset;
causing a set of users to be polled to provide predictions of future performance of the asset;
receiving predictions of the future performance of the asset from at least some of the set of users;
providing for display the information-dense user interface, the information-dense user interface including a visual representation of the historical price of the asset over time overlaid with an indication of a first distribution of the historical performance predictions, and an indication of second distribution of the received predictions of the future performance of the asset.

19. The method of claim 18, wherein the indication of the first distribution of the historical performance predictions comprises a set of geometric shapes, each geometric shape positioned according to a corresponding price range and having a visual property corresponding to a number of users that predicted the asset price would be within the corresponding price range, wherein each geometric shape has an x-axis position indicating a time range and a y-axis position indicating a price prediction, and the visual property is a shading intensity.

20. The method of claim 18, wherein the indication of the second distribution of the received predictions comprises a set of geometric shapes, each geometric shape positioned according to a corresponding price range and having a visual property corresponding to a number of users that predicted the asset price will be within the corresponding price range, wherein each geometric shape has a y-axis position indicating a price prediction, and the visual property is a shading intensity.
